(19) United States
(12) Patent Application Publication
(10) Pub. No.: US 2018/0031895 A1
(43) Pub. Date: Feb. 1, 2018

(54) DISPLAY DEVICE

(71) Applicant: Japan Display Inc., Minato-ku (JP)

(72) Inventors: Gen KOIDE, Tokyo (JP); Naoshi GOTO, Tokyo (JP)

(73) Assignee: Japan Display Inc., Minato-ku (JP)

(21) Appl. No.: 15/661,110

(22) Filed: Jul. 27, 2017

(30) Foreign Application Priority Data
Jul. 29, 2016 (JP) 2016-149967

(51) Int. Cl. G02F 1/1345; G02F 1/1343; G02F 1/1335; G02F 1/1333; G02F 1/1368; G02F 1/1362

(52) U.S. Cl. CPC G02F 1/13458; G02F 1/1368; G02F 1/136286; G02F 1/13452; G02F 1/133512; G02F 1/13338; G02F 1/134363; G02F 2001/13685; G02F 2201/121; G02F 2201/123; G02F 1/133514

(57) ABSTRACT

According to one embodiment, a display device includes a first substrate including a first area in which an image is displayed and a second area located around the first area, and a wiring substrate overlapping a first side and the second area of the first substrate, the first substrate includes a third connection terminal group, a fourth connection terminal group located on one of sides of the third connection terminal group and composed of a connection terminal smaller than a connection terminal of the third connection terminal group, and a fifth connection terminal group located on the other side of the third connection terminal group and includes of a connection terminal smaller than a connection terminal of the third connection terminal group.

### CROSS-REFERENCE TO RELATED APPLICATIONS

This application is based upon and claims the benefit of priority from Japanese Patent Application No. 2016-149967, filed Jul. 29, 2016, the entire contents of which are incorporated herein by reference.

### FIELD

Embodiments described herein relate generally to a display device.

### BACKGROUND

Recently, various technologies of forming a display device in a narrower frame shape have been reviewed. For example, a technology of electrically connecting a line portion including an in-hole connecting portion inside a hole penetrating an inner surface and an outer surface of a first substrate formed of resin with a line portion provided on an inner surface of a second substrate formed of resin, by an inter-substrate connecting portion, has been disclosed.

### BRIEF DESCRIPTION OF THE DRAWINGS

FIG. 1 is a plan view showing a configuration example of a display device DSP according to the embodiments.

FIG. 2 is a plan view showing a configuration example of a display panel PNL.

FIG. 3 is a diagram showing an equivalent circuit concerning image display of the display device DSP.

FIG. 4 is a cross-sectional view showing a partial structure of the display panel PNL.

FIG. 5 is a cross-sectional view showing a structural example of a pixel switch PSW.

FIG. 6 is an illustration showing an example of a principle of detecting an object contacting or approaching a display area.

FIG. 7 is a plan view showing a structural example of connection terminal groups TG1 to TG5.

FIG. 8 is an illustration for explanation of a relationship in size between a connection terminal T3 and a connection terminal T4.

FIG. 9 is a plan view showing an arrangement example of supply lines 31, 32, and 33.

FIG. 10 is a plan view showing an arrangement example of supply lines 41, 42, and 43.

FIG. 11 is a diagram showing a configuration example of the second switch group SG2.

FIG. 12 is a plan view showing an arrangement example of supply lines 51, 53, 55, and 57, and a scanner SC.

FIG. 13 is a diagram for explanation of operations of the scanner SC.

FIG. 14 is a cross-sectional view showing a configuration example of lines drawn from first to fifth connection terminal groups.

FIG. 15 is a cross-sectional view showing another configuration example of lines drawn from the first to fifth connection terminal groups.

FIG. 16 is a plan view showing an arrangement example of connection terminals 4 and gauges GG.

FIG. 17 is a cross-sectional view showing a configuration example of the connection terminal T4.

FIG. 18 is a cross-sectional view showing a configuration example of the gauge GG.

FIG. 19 is a cross-sectional view showing the display panel PNL cut along line A-B in FIG. 1.

FIG. 20 is a plan view showing a configuration example of a non-display area NDA and a terminal area NA.

FIG. 21 is a cross-sectional view showing a configuration example of a lead-out line LW.

FIG. 22 is a cross-sectional view showing another configuration example of the lead-out line LW.

FIG. 23 is a cross-sectional view showing an example of connection of the lead-out line LW shown in FIG. 21.

FIG. 24 is a cross-sectional view showing an example of connection of the lead-out line LW shown in FIG. 22.

FIG. 25 is a plan view showing intersecting lead-out lines LW.

FIG. 26 is a cross-sectional view seen along line A-B in FIG. 25.

### DETAILED DESCRIPTION

In general, according to one embodiment, a display device comprising: a first substrate including a first area in which an image is displayed and a second area located around the first area; and a wiring substrate overlapping a first side and the second area of the first substrate, the first substrate comprising: a third connection terminal group; a fourth connection terminal group located on one of sides of the third connection terminal group and composed of a connection terminal smaller than a connection terminal of the third connection terminal group; and a fifth connection terminal group located on the other side of the third connection terminal group and composed of a connection terminal smaller than a connection terminal of the third connection terminal group.

According to another embodiment, a display device, comprising: a first substrate including a first area in which an image is displayed and a second area located around the first area; a second substrate opposed to the first substrate; and a wiring substrate overlapping a first side of the first substrate and the second area, wherein the first substrate comprises a connection terminals disposed near an edge of the first side in the second area, the second area of the first substrate includes a first portion overlapping the second substrate and a second portion extending from an edge portion of the second substrate, the plurality of connection terminals are formed at the second portion, the second portion includes a first line, a first insulating film covering the first line, a second line on the first insulating film, a second insulating film covering the second line, and a third line on the second insulating film, and the third line is connected to at least one of the plurality of connection terminals through a contact hole formed in the second insulating film.

Embodiments will be described hereinafter with reference to the accompanying drawings. The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes and the like, of the respective parts are illustrated schematically in the drawings, rather than as an accurate representation of what is implemented. However, such schematic illustration is merely exemplary, and in no way restricts the interpretation of the invention. In addition, in the specification and drawings, structural elements which function in the same or a similar manner to those described in connection with preceding drawings are denoted by like reference numbers, detailed description thereof being omitted unless necessary.

The display device DSP according to the present embodiments can be used for, for example, various devices such as smartphones, tablet terminals, mobile telephones, notebook computers, and game consoles. The major configuration explained in the embodiments can be applied to a liquid crystal display device, a self-luminous display device such as an organic electroluminescent display device, an electronic paper display device comprising an electrophoretic element and the like, a display device employing micro-electromechanical systems (MEMS), or a display device employing electrochromism.

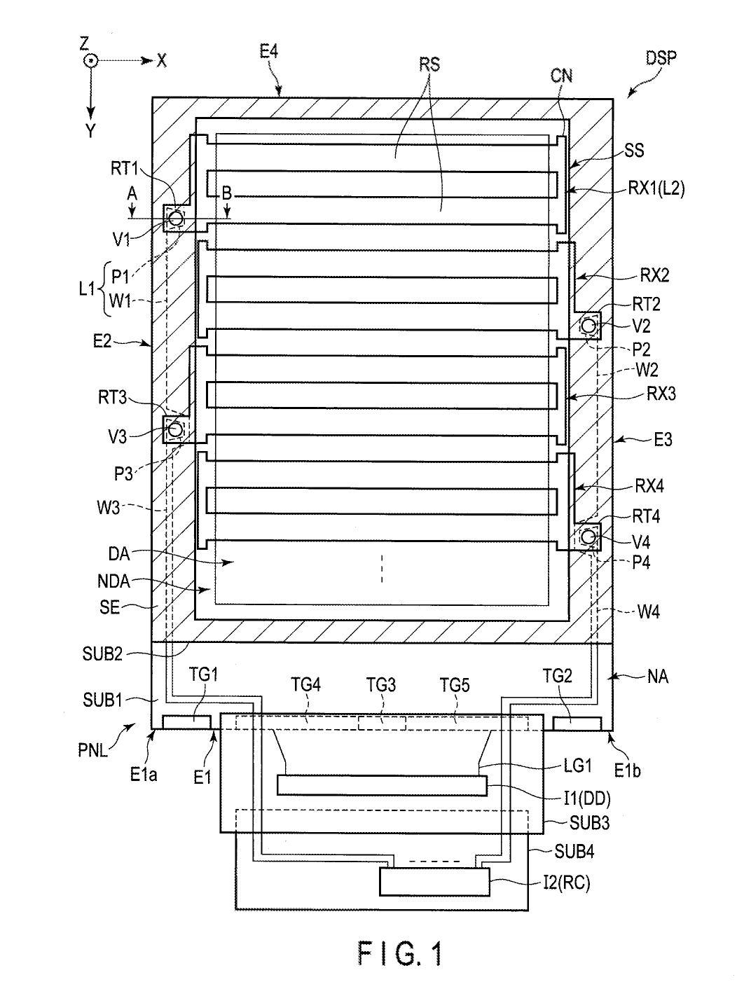

FIG. 1 is a plan view showing a configuration example of a display device DSP according to the embodiments.

A liquid crystal display device equipped with a sensor SS will be explained here as an example of the display device DSP. The first direction X is a direction in which sides E1 and E4 extend. The second direction Y is a direction which intersects the first direction X and in which sides E1 and E3 extend. The third direction Z is a direction which intersects the first direction X and the second direction Y and is a normal of a surface of the display panel PNL (first substrate SUB1 and second substrate SUB2). In the example illustrated, the first direction X, the second direction Y, and the third direction Z are orthogonal to each other but may intersect at an angle other than 90 degrees.

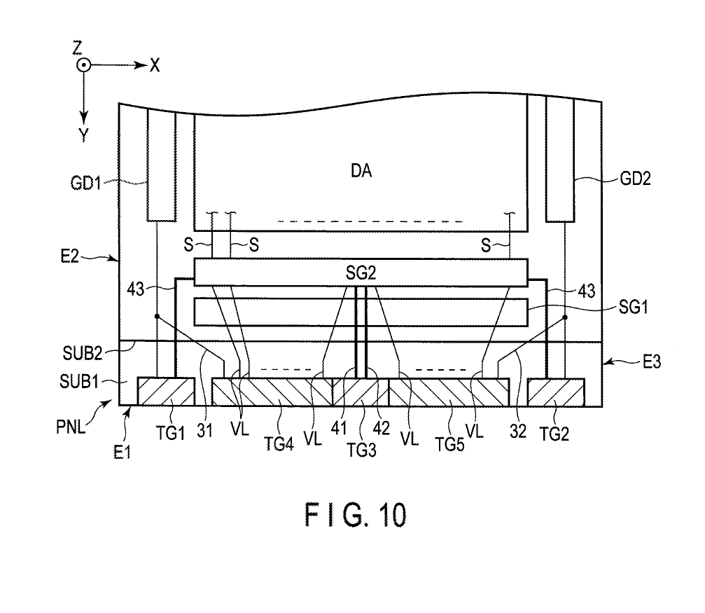

The display device DSP comprises a display panel PNL, IC chips I1 and I2, wiring substrates SUBS and SUB4, and the like. The display panel PNL is a liquid crystal display panel, including a first substrate SUB1, a second substrate SUB2, a sealing material SE and a display function layer (a liquid crystal layer LC to be explained later). The second substrate SUB2 is opposed to the first substrate SUB1. The sealing material SE corresponds to a portion represented by upward-sloping hatch lines in FIG. 10 and bonds the first substrate SUB1 to the second substrate SUB2.

The display panel PNL may be, for example, a transmissive display panel having a transmissive display function of displaying an image by urging the light from the lower side of the first substrate SUB1 to be selectively transmitted, a reflective display panel having a reflective display function of displaying an image by urging the light from the upper side of the second substrate SUB2 to be selectively transmitted, or a transflective display panel having the transmissive display function and the reflective display function.

The display panel PNL includes a display area DA in which an image is displayed, and a frame-shaped non-display area NDA surrounding the display area DA. The display area DA is, for example, located on an inner side surrounded by the sealing material SE. The sealing material SE is located in the non-display area NDA. The display area DA corresponds to a first area on the first substrate SUB1 and the non-display area NDA corresponds to a second area on the first substrate SUB1.

In the example illustrated, the first substrate SUB1 has a square shape having a pair of sides E1 and E4 opposed in the second direction Y and a pair of sides E2 and E3 opposed in the first direction X. The side E2 extends from an edge E1a of the side edge E1 in the second direction Y. The side edge E3 extends from an edge E1b of the side edge E1 in the second direction Y. The second substrate SUB2 has a square shape smaller than the first substrate SUB1, and overlaps the sides E2, E3, and E4 and is spaced apart from the side E1 in the second direction Y in planar view. In other words, the first substrate SUB1 has a terminal area BA which is not opposed to the second substrate SUB2, on a side close to the side E1 of the second area.

The first substrate SUB1 includes first to fifth connection terminal groups TG1 to TG5 to mount an external circuit board in the terminal area NA. The external circuit board is electrically connected to various lines of the first substrate SUB1 via the first to fifth connection terminal groups TG1 to TG5. In the example illustrated, the side SA corresponds to a side of the first substrate SUB1. The first to fifth connection terminal groups TG1 to TG5 are formed on a surface of the side of the first substrate SUB1 which is opposed to the second substrate SUB2. The first connection terminal group TG1 is disposed near to the edge E1a of the first side E1. The second connection terminal group TG2 is disposed near to the other edge E1b of the first side E1. The third connection terminal group TG3 is located between the first connection terminal group TG1 and the second connection terminal group TG2. The fourth connection terminal group TG4 is located between the first connection terminal group TG1 and the third connection terminal group TG3, and the fifth connection terminal group TG5 is located between the third connection terminal group TG3 and the second connection terminal group TG2.

Each of the first to fifth connection terminal groups TG1 to TG5 comprises a plurality of connection terminals arranged in the first direction X. The connection terminals of the fourth connection terminal group TG4 and the fifth connection terminal group TG5 are smaller than the connection terminals of the first to third connection terminal groups TG1 to TG3, in planar view. This is because the first to third connection terminal groups TG1 to TG3 are used for connection of the wiring substrate for inspection in an inspection of quality of the display panel PNL and, to facilitate alignment of a connector of the wiring substrate for inspection and a connector of the first substrate SUB1, the connection terminals of the first to third connection terminal groups TG1 to TG3 are desirably large. In contrast, this is because the fourth connection terminal group TG4 and the fifth connection terminal group TG5 are connected to the wiring substrate SUB3 to mediate supply and reception of signals necessary for image display and sensing of the sensor, and the connection terminals of the fourth connection terminal group TG4 and the fifth connection terminal group TG5 are desirably small to densely arrange a number of connection terminals. It should be noted that the third connection terminal group TG3 is used not only for a wiring substrate for inspection, but also for connection of the wiring substrate SUB3. For example, the first to fifth connection terminal groups TG1 to TG5 are arranged along the side E1 in the first direction X.

The third connection terminal group TG3 overlaps the side E1 and the terminal area NA (second area). The wiring substrate SUB3 is located between the first connection terminal group TG1 and the second connection terminal group TG2, and electrically connected with the third to fifth connection terminal groups TG3 to TG5. The wiring substrate SUB4 is connected to a surface on a side of the wiring substrate SUB3 which is opposed to the first substrate SUB1. The wiring substrate SUB4 is electrically connected to the display panel PNL via the wiring substrate SUB3. The IC chip I1 is mounted on the wiring substrate SUB3, and the IC chip I2 is mounted on the wiring substrate SUB4. The IC chip I1 is electrically connected with the third to fifth connection terminal groups TG3 to TG5 by a line group LG1 disposed on the wiring substrate SUB3. The IC chip I1 is not limited to the example illustrated, but may be mounted on the first substrate SUB1 extending to an outer side than the second substrate SUB2 or mounted on an external circuit board connected to the wiring substrate SUB3 such as the wiring substrate SUB4. The IC chip I1 is not limited to the example illustrated either, but may be mounted on the first substrate SUB1 or the wiring substrate SUB3 or mounted on an external circuit board connected to the wiring substrate SUB4. The IC chip I1 incorporates, for example, a display driver DD which outputs a signal necessary to display an image. The display driver DD at least several parts of scanning line drive circuits GD1 and GD2 which will be explained later. In addition, the IC chip I1 incorporates, for example, a detection circuit RC which functions as a touch panel controller or the like.

The sensor SS executes sensing to detect contact with or approach to the liquid crystal display device DSP, of an object. The sensor SE comprises a plurality of detection electrodes RX (RX1, RX2, . . . ) The detection electrodes RX are provided on the second substrate SUB2 and correspond to a second conductive layer L2. The detection electrodes RX extend in the first direction X, and are arranged in the second direction Y so as to be spaced apart from each other. Detection electrodes RX1 to RX4 are illustrated as the detection electrodes RX, but a structural example of the detection electrode RX1 will be specifically explained here.

The detection electrode RX1 comprises detectors RS, a terminal RT1 and a connector CN.

The detectors RS are located in the display area DA and extend in the first direction X. In the detection electrode RX1, the detectors RS primarily detect contact or approach of an object and outputs a sensor detection signal. In the example illustrated, each detector RS is formed in a strip shape but may be formed of a transparent conductive material in a flat shape or formed of an assembly of fine metal wires. In addition, the detectors RS may be formed of a combination of a transparent conductive material and an assembly of fine metal wires. One detection electrode RX1 comprises two detectors RS but may comprise three or more detectors RS or one detector RS.

The terminal RT1 is located on the side E2 of the non-display area NDA and is connected to the detectors RS. In other words, the terminal RT1 is located opposed to the second area of the first substrate SUB1. The connector CN is located on the side E3 of the non-display area NDA to connect the detectors RS to each other. In FIG. 1, the side E2 corresponds to the left side of the display area DA and the side E3 corresponds to the right side of the display area DA. A part of the terminal RT1 is formed at a position at which the part and the sealing material SE overlap each other in planar view.

In contrast, the first substrate SUB1 includes a pad P1 and a detection line W1 corresponding to the first conductive layer L1. The pad P1 and the detection line W1 are located on the side E2 of the non-display area NDA and overlap the sealing material SE in planar view. The pad P1 is formed at a position at which the pad P1 and the terminal RT1 overlap each other in planar view. The detection line W1 is connected to the pad P1 to extend in the second direction Y, and is connected to the fourth connection terminal group TG4. A line electrically connected to the detection line E1 is drawn to the outside of the line group LG1 (i.e., the side close to the edge E1a) on the wiring substrate SUB3, and is electrically connected with the detection circuit RC of the IC chip I2 on the wiring substrate SUB4. In other words, the sensor detection signal is transmitted by the detection line W1 and the wiring substrate SUB3.

The first conductive layer L1 (pad P1) and the second conductive layer L2 (terminal RT1) are electrically connected to each other via a contact hole V1. The contact hole V1 is formed at a position at which the terminal RT1 is opposed to the pad P1. In addition, the contact hole V1 may penetrate the sealing material SE and the second substrate SUB2 including the terminal RT1 and may also penetrate the pad P1. In the example illustrated, the contact hole V1 is formed in a circular shape in planar view, and the shape is not limited to the example illustrated but may be the other shape such as an elliptic shape. As explained later, a connecting material C is provided in the contact hole V1. The terminal RT1 is thereby electrically connected to the pad P1. In other words, the detection electrode RX1 provided on the second substrate SUB2 is electrically connected with the detection circuit RC via the wiring substrate SUB3 connected to the first substrate SUB1. The detection circuit RC reads the sensor signal output from the detection electrode RX and detects contact or approach of the object, position coordinates of the object and the like.

In the example illustrated, the terminals RT1, RT3, . . . , the pads P1, P3, . . . , the detection lines W1, W3, . . . , and the contact holes V1, V3, . . . , of the odd-numbered detection electrodes RX1, RX3, . . . are located on the side E2. In addition, the terminals RT2, RT4, . . . , the pads P2, P4, . . . , the detection lines W2, W4, . . . , and the contact holes V2, V4, . . . , of the even-numbered detection electrodes RX2, RX4, . . . are located on the side E3. In this layout, a width of the side E2 and a width of the side E3 in the non-display area NDA can be made equal and the frame can be suitably narrowed.

As illustrated in the drawing, in the layout in which the pad P3 is closer to the wiring substrate SUB3 than the pad P1, the detection line W1 is disposed to bypass the inside of the pad P3 (i.e., the side close to the display area DA) and to be arranged on the inside of the detection line W3 between the pad P3 and the wiring substrate SUB3. The detection line W2 is disposed to bypass the inside of the pad P4 and to be arranged on the inside of the detection line W4 between the pad P4 and the wiring substrate SUB3.

According to the embodiments, the connection terminal groups and the routing lines to receive the sensor detection signals do not need to be disposed on the second substrate SUB2 as compared with the configuration example in which the wiring substrate for receiving the sensor detection signals output from the detection electrodes RX are mounted on the second substrate SUB2. For this reason, in the X-Y plane defined by the first direction X and the second direction Y, the size of the second substrate SUB2 can be reduced and the frame width of a periphery of the display device DSP can be reduced.

Furthermore, the number of the connection terminals can be reduced by using the third connection terminal group TG3 for connection with the wiring board for inspection and also using the third connection terminal group TG3 for connection with the wiring substrate SUB3, in the display device DSP. The connection terminal electrically connected with the first substrate SUB1 and the second substrate SUB2 can be entirely disposed on the side E1. In addition, in the present embodiment, the connection terminal groups for connection of the wiring substrate SUB3 (third to fifth connection terminal groups TG3 to TG5) can be disposed widely in the first direction X, as compared with the configuration example in which the connection terminal groups for connection of the wiring substrate for inspection are disposed at two portions on both edge sides of the connection terminal group for connection of the wiring substrate SUB3. For this reason, reduction in density and reduction in bending on the lines drawn from the third to fifth connection terminal groups TG3 to TG5 toward the display area DA can be implemented. In other words, degradation in the display quality of the display device DSP and the detecting ability of the sensor SS caused by damage on the lines and the interference of the lines can be suppressed.

Next, details of the components of the display device DSP according to the embodiments and the operations of the components will be explained with reference to the drawing.

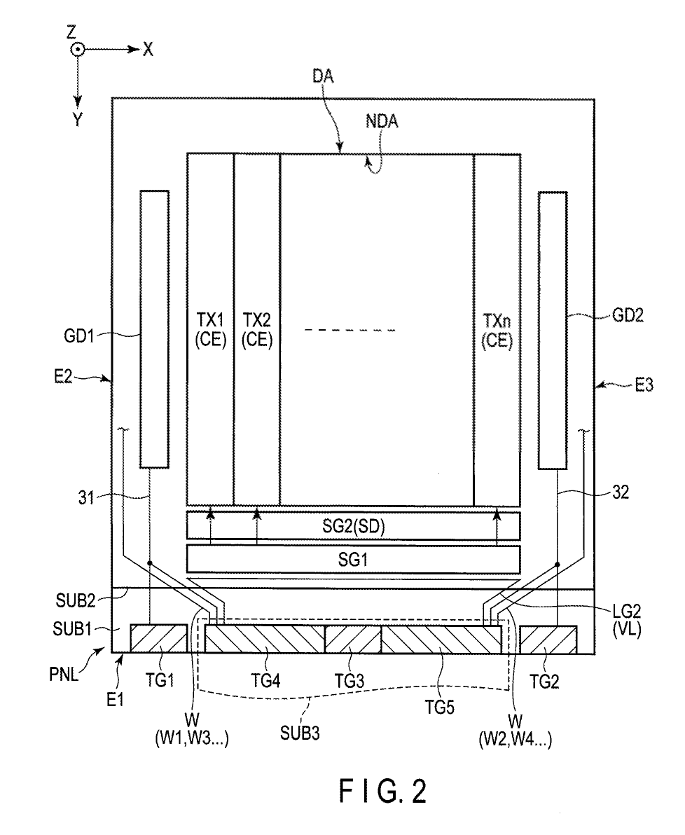

FIG. 2 is a plan view showing a configuration example of a display panel PNL.

The display panel PNL illustrated in the drawing comprises not only the above-explained elements, but also a plurality of drive electrodes TX (TX1 to TXn), the first switch group SG1, the second switch group SG2, scanning line drive circuits GD1 and GD2, and the like. The second switch group SG2 is included in, for example, a selector SD and is often called a multiplexer.

The drive electrodes TX1 to TXn extend in the second direction Y and are arranged in the first direction X, in the display area DA. In other words, the drive electrodes TX intersect the above-explained detection electrodes RX in planar view. The drive electrodes TX1 to TXn can be formed of, for example, a transparent conductive material such as indium tin oxide (ITO) or indium zinc oxide (IZO). The drive electrodes TX1 to TXn are, for example, formed inside the display panel PNL, i.e., on the first substrate SUB1.

All the first switch group SG1, the second switch group SG2, and the scanning line drive circuits GD1 and GD2 are formed in the non-display area NDA of the first substrate SUB1. These elements can be formed on the first substrate SUB1 by employing, for example, a process of forming a pixel switch PSW to be explained later. The first switch group SG1 is arranged along the side E1 and disposed more closely to the display area DA than the first to fifth connection terminal groups TG1 to TG5. The first switch group SG1 is electrically connected to the drive electrodes TX1 to TXn and supplies a sensor drive signal to drive the sensor SS or a common voltage to display an image to the electrodes. The second switch group SG2 is arranged along the side E1 and disposed more closely to the display area DA than the first switch group SG1. The first switch group SG1 and the second switch group SG2 are supplied with various signals by a line group LG2. The line group LG2 includes a plurality of video lines VL that will be explained later. The line group LG2 is electrically connected to the third to fifth connection terminal groups TG3 to TG5.

The scanning line drive circuit GD1 is arranged along the side E2 in the non-display area NDA and controls supply of a scanning signal to the display area DA. The scanning line drive circuit GD2 is arranged along the side E3 in the non-display area NDA and controls supply of a scanning signal to the display area DA.

Supply lines 31 and 32 are formed on the first substrate SUB1. The supply line 31 is a line to supply a control signal from the fourth connection terminal group TG4 to the scanning line drive circuit GD1. The supply line 31 connects the fourth connection terminal group TG4 with the scanning line drive circuit GD1 and is branched to be connected to the first connection terminal group TG1, too. The supply line 32 is a line to supply a control signal from the fifth connection terminal group TG5 to the scanning line drive circuit GD2. The supply line 32 connects the fifth connection terminal group TG5 with the scanning line drive circuit GD2 and is branched to be connected to the second connection terminal group TG2, too.

The supply line 31 is disposed nearer to the edge E2 than the line group LG2. The supply line 32 is disposed nearer to the edge E3 than the line group LG2. The detection lines W (W1, W3, . . . ) extending along the edge E2 are disposed nearer to the edge E2 than the supply line 31 which connects the fourth connection terminal group TG4 with the scanning line drive circuit GD1. The detection lines W (W2, W4, . . . ) extending along the edge E3 are disposed nearer to the edge E3 than the supply line 32 which connects the fifth connection terminal group TG5 with the scanning line drive circuit GD2. In other words, the supply lines 31 and 32 are located on the outer side than the line group LG2 and located on the inner side than the detection lines W, in the first direction X, in planar view. However, the supply lines 31 and 32 are located on the outer side than the detection lines W, at least partially, in a distance between the first connection terminal group TG1 and the node and a distance between the second connection terminal group TG2 and the node, respectively.

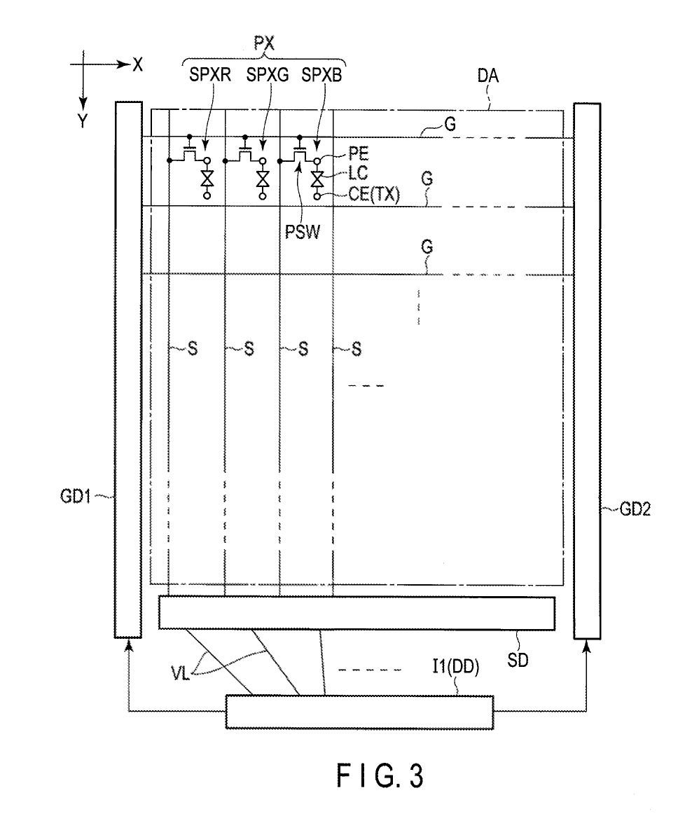

FIG. 3 is a diagram showing an equivalent circuit concerning image display of the display device DSP.

The display device DSP comprises a plurality of scanning lines G, a plurality of signal lines S intersecting the scanning lines G, the first scanning line drive circuit GD1, the second scanning line drive circuit GD2, and a selector (RGB switch) SD. The selector SD is connected with a display driver DD via a plurality of video lines VL.

The scanning lines G extend in the first direction X and are arranged in the second direction Y, in the display area DA. The signal lines S extend in the second direction Y and are arranged in the first direction X, in the display area DA. The scanning lines G and the signal lines S are formed on the first substrate SUB1. The scanning lines G are connected to the first scanning line drive circuit GD1 and the second scanning line drive circuit GD2. Each of the signals S is connected to the selector SD.

In the example illustrated, each of areas sectioned by the scanning lines G and the signal lines S corresponds to a sub-pixel SPX. For example, in the embodiments, the pixel PX is composed of a sub-pixel SPXR corresponding to red, a sub-pixel SPXG corresponding to green, and a sub-pixel SPXB corresponding to blue. The pixel PX may further comprise sub-pixels SPX corresponding to the other colors such as white and yellow.

Each of the sub-pixels SPX comprises a pixel switch PSW. The pixel switch PSW is electrically connected with the scanning line G, the signal line S, and the pixel electrode PE. In the display, the drive electrode TX is set at a common potential and functions as what is called a common electrodes CE.

The first scanning line drive circuit GD1 and the second scanning line drive circuit GD2 sequentially supply scan signals to the scanning lines G. The selector SD is controlled by the IC chip I1 (display driver DD) to selectively supply video signals to the signal lines S. The scan signal is supplied to the scanning line G connected to a certain pixel switch PSW, and the video signal is supplied to the signal line S connected to the pixel switch PSW. A voltage according to the video signal is applied to the pixel electrode PE, and alignment of the liquid crystal molecules of the liquid crystal layer LC is varied from an initial alignment state in which no voltages are applied, by the electric field produced between the pixel electrode PE and the common electrode CE. The images are displayed on the display area DA by this operation.

Next, an example of the configuration of the display panel PNL will be explained with reference to the cross-sectional view.

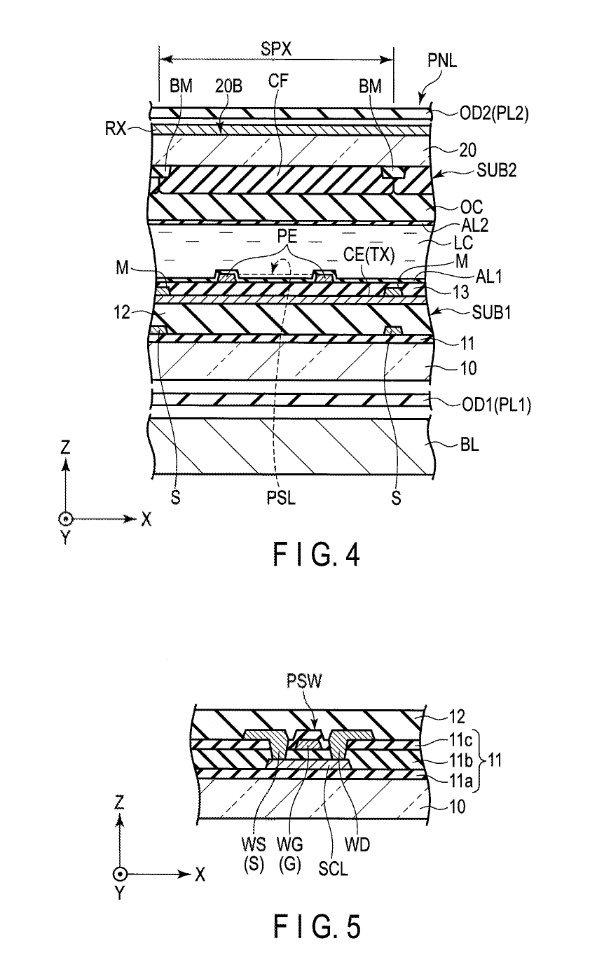

FIG. 4 is a cross-sectional view showing a partial structure of the display panel PNL.

A cross-sectional view obtained by cutting in the first direction X the area corresponding to one sub-pixel SPX of the display device DSP is illustrated.

The display panel PNL illustrated in the drawing has a configuration corresponding to a display mode which mainly uses a lateral electric field approximately parallel to the substrate surface. The display panel PNL may be configured to correspond to a display mode using a longitudinal electric field perpendicular to the surface of the substrate, an electric field inclined to the surface of the substrate or a combination of these electric fields. In the display mode using the lateral electric field, for example, a structure comprising both the pixel electrode PE and the common electrode CE on either of the first substrate SUB1 and the second substrate SUB2 can be applied. In the display mode using the lateral electric field or the inclined electric field, for example, a structure comprising either of the pixel electrode PE and the common electrode CE on the first substrate SUB1 and comprising the other of the pixel electrode PE and the common electrode CE on the second substrate SUB2 can be applied. The substrate surface is a surface parallel to the X-Y plane.

The first substrate SUB1 comprises the first insulating substrate 10, the signal lines S, the common electrode CE, the metal layer M, the pixel electrodes PE, an insulating film 11, an insulating film 12, an insulating film 13, a first alignment film AL1, and the like. Various insulating films interposed between the pixel switches and the scanning lines are not illustrated.

The insulating film 11 is located on the first insulating substrate 10. A semiconductor layer of the scanning lines and pixel switches (not shown) is located between the first insulating substrate 10 and the insulating film 11. The signal lines S are located on the insulating film 11. The insulating film 12 is located on the signal lines S and the insulating film 11. The common electrode CE is located on the insulating film 12 and opposed to the pixel electrodes PE. The metal layer M is in contact with the common electrode CE, directly above the signal lines S. In the example illustrated, the metal layer M is located on the common electrode CE but may be located between the common electrode CE and the insulating film 12. The insulating film 13 is located on the common electrode CE and the metal layer M. The pixel electrodes PE are located on the insulating film 13. The pixel electrodes PE are opposed to the common electrode CE via the insulating film 13. In addition, each pixel electrode PE includes a slit SL at a position opposed to the common electrode CE. The first alignment film AL1 covers the pixel electrodes PE and the insulating film 13.

The scanning lines G, the signal lines S, and the metal layer M are formed of metals such as molybdenum, tungsten, titanium and aluminum and may be formed in a single-layer structure or a multi-layer structure. The common electrode CE and the pixel electrodes PE are formed of a transparent conductive material such as ITO or IZO. The insulating film 11 and the insulating film 13 are inorganic insulating layers while the insulating film 12 is an organic insulating film.

The illustrated configuration example indicates the structure (hereinafter called a P-TOP structure) in which the pixel electrode PE is disposed nearer to the liquid crystal layer LC than the common electrode CE, but the configuration of the first substrate SUB1 is not limited to this. In the configuration of the first substrate SUB1, the pixel electrodes PE may be located between the insulating film 12 and the insulating film 13, and the common electrode CE may be located between the insulating film 13 and the first alignment film AL1. In the structure (hereinafter called a C-TOP structure) in which the common electrode CE is disposed nearer to the liquid crystal layer LC than the pixel electrode PE, the pixel electrode PE is shaped in a flat plate which does not include a slit and the common electrode CE includes a slit opposed to the pixel electrode PE. In addition, the pixel electrodes PE and the common electrode CE may be shaped in combs and disposed to be engaged with each other.

The second substrate SUB2 includes the second insulating substrate 20, a light-shielding layer BM, a color filter CF, an overcoat layer OC, a second alignment film AL2, and the like. The first insulating substrate 10 and the second insulating substrate 20 are formed of, for example, a glass substrate or a resin substrate.

The light-shielding layer BM and the color filter CF are located on a side of the second insulating substrate 20 which is opposed to the first substrate SUB1. The light-shielding layer BM sections the pixels and are located directly above the signal lines S. The color filter CF is opposed to the pixel electrode PE, and the light shielding layer BM overlaps a part of the color filter CF. The color filter CF includes a red color filter, a green color filter and a blue color filter. The overcoat layer OC covers the color filter CF. The second alignment film AL2 covers the overcoat layer OC.

The color filter CF may be disposed on the first substrate SUB1. The color filter CF may include color filters of four or more colors. On a pixel displaying a white color, a white color filter or an uncolored resin material may be disposed or the overcoat layer OC may be disposed without disposing the color filter.

The detection electrode Rx is located on the surface 20B of the second insulating substrate 20. The detection electrode RX corresponds to the second conductive layer L2, and may be formed of a metal material or may also be formed of a transparent conductive material such as ITO or IZO. The detection electrode Rx may be formed by depositing a transparent conductive material layer on a metal material layer or formed of a conductive organic material or a dispersing element of a fine conductive substance, and the like.

A first optical element OD1 including a first polarizer PL1 is located between the first insulating substrate 10 and an illumination device BL. A second optical element OD2 including a second polarizer PL2 is located on the detection electrodes Rx. Each of the first optical element OD1 and the second optical element OD2 may include a retardation film as needed.

FIG. 5 is a cross-sectional view showing a structural example of a pixel switch PSW.

The pixel switch PSW is composed of, for example, a thin thin-film transistor (TFT). More specifically, the pixel switch PSW comprises a semiconductor layer SCL, a gate electrode WG, a source electrode WS, and a drain electrode WD. In addition, the insulating film 11 includes insulating films 11a, 11b, and 11c.

The insulating film 11a is disposed on the first insulating substrate 10. The semiconductor layer SCL is located on the insulating film 11a. The insulating film 11b covers the insulating film 11a and the semiconductor layer SCL. The gate electrode WG is disposed on the insulating film 11b and opposed to the semiconductor layer SCL via the insulating film 11b. The insulating film 11c covers the insulating film 11b and the gate electrode WG. The source electrode WS and the drain electrode WD are disposed on the insulating film 11c and electrically connected with the semiconductor layer SCL through contact holes which penetrate the insulating films 11a and 11b. The insulating film 11c, the source electrode WS, and the drain electrode WD are covered with an insulating film 12. The gate electrode WG is electrically connected with the scanning line G. In the example illustrated, the electrode electrically connected with the signal line S is called the source electrode WS and the electrode electrically connected with the pixel electrode PE is called the drain electrode WD. The TFT illustrated in the drawing is a top-gate TFT in which the gate electrode WG is located above the semiconductor layer SCL. However, the configuration of the TFT is not limited to this but the TFT may be a bottom-gate TFT in which the gate electrode WG is located under the semiconductor layer SCL.

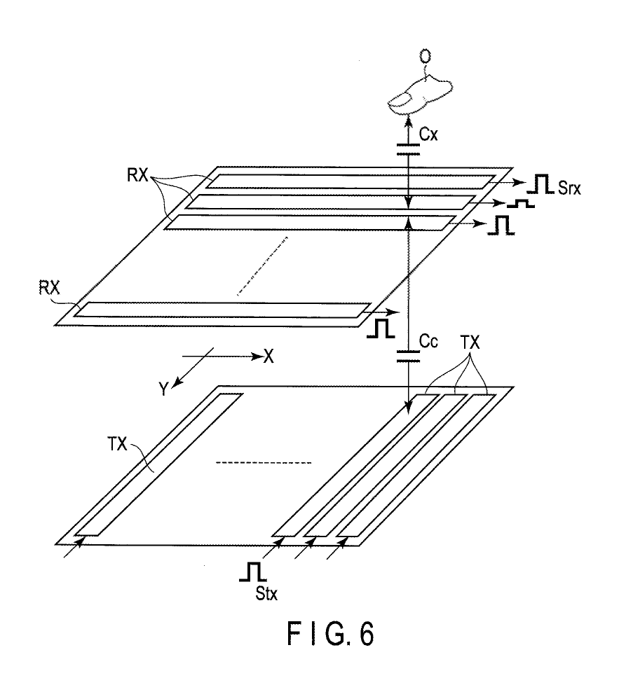

FIG. 6 is an illustration showing an example of a principle of detecting an object contacting or approaching a display area. Capacitance Cc exists between the drive electrodes TX and the detection electrodes RX opposed to each other. When sensor drive signals Stx are supplied to the drive electrodes TX, sensor detection signals Srx are obtained from the detection electrodes RX since currents flow to the detection electrodes RX via the capacitance Cc. The sensor drive signal Stx is, for example, a rectangular pulse while the sensor detection signal Srx is a rectangular pulse of the voltage corresponding to the sensor drive signal Stx.

If an object O which is a conductive material such as a user's finger approaches the display device DSP, the capacitance Cx is generated between the object O and the detection electrode RX close to the object O. When the sensor drive signals Stx are supplied to the drive electrodes TX, the waveform of the sensor detection signal Srx output from the detection electrode RX close to the object O is varied due to an influence from the capacitance Cx. In other words, the detection circuit RC of the IC chip I2 can detect the object O which contacts or approaches the display device DSP, based on the sensor detection signals Srx obtained from the respective detection electrodes RX. A touch detector IC4 can detect the position of the object O in the first direction X and the second direction Y, based on the sensor detection signals Srx obtained from the detection electrodes RX in time phases, respectively, when the sensor drive signals Stx are sequentially supplied to the respective drive electrodes TX by time division. The above-explained method is called a mutual-capacitive method or a mutual detection method.

As explained above, the display device DSP of the embodiments use the drive electrodes TX for the image display and the touch detection.

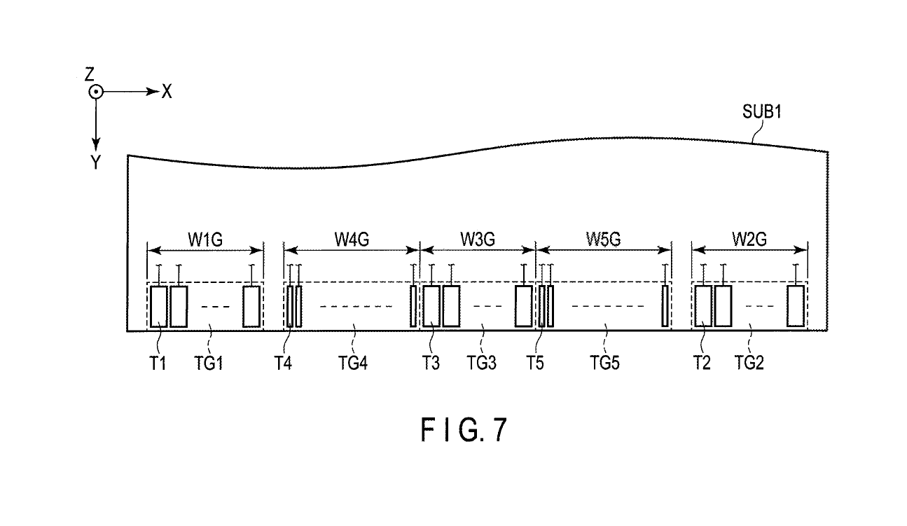

FIG. 7 is a plan view showing a structural example of connection terminal groups TG1 to TG5.

A width of the first connection terminal group TG1 in the first direction X is W1G, a width of the second connection terminal group TG2 in the first direction X is W2G, a width of the third connection terminal group TG3 in the first direction X is W3G, a width of the four connection terminal group TG4 in the first direction X is W4G, and a width of the fifth connection terminal group TG5 in the first direction X is W5G. In the example illustrated, the width W3G is equal to the width W1G and the width W2G. In addition, the width W4G is equal to the width W5G and different from the width W3G. Each of the widths W4G and W5G is greater than, for example, the width W3G.

The first connection terminal group TG1 includes a plurality of connection terminals T1, the second connection terminal group TG2 includes a plurality of connection terminals T2, the third connection terminal group TG3 includes a plurality of connection terminals T3, the four connection terminal group TG4 includes a plurality of connection terminals T4, and the fifth connection terminal group TG5 includes a plurality of connection terminals T5. The connection terminals T1 to T5 are arranged on the same straight line in the first direction X. In the example illustrated, the size and pitch of the connection terminals T3 are equal to the size and pitch of the connection terminals T1 and also equal to the size and pitch of the connection terminals T2. In addition, the size and pitch of the connection terminals T4 are equal to the size and pitch of the connection terminals T5 and also equal to the size and pitch of the connection terminals T3. The size of the connection terminals T1 to T5 indicates an area in planar view but can be interpreted as the width in the first direction X. In addition, pitches of the connection terminals T1 to T5 indicate intervals of arrangement in the first direction X and, for example, the pitch of the connection terminals T1 corresponds to a distance from the left side of a connection terminal T1 in the drawing to the left side of the adjacent connection terminal T1 in the drawing.

According to the present configuration example, since the sizes and pitches of the connection terminals T1 to T3 are equal, wiring substrates of the same standards can be used as wiring substrates for inspection connected to the first to third connection terminal groups TG1 to TG3.

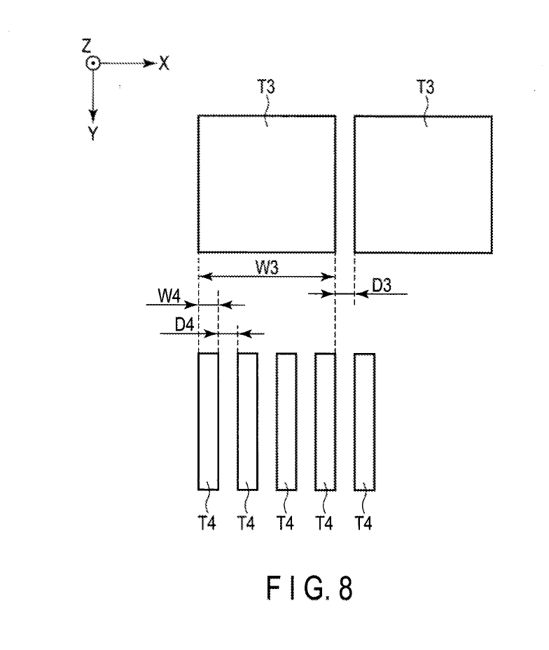

FIG. 8 is an illustration for explanation of a relationship in size between a connection terminal T3 and a connection terminal T4.

A width of the connection terminal T3 in the first direction X is W3, and an interval between the adjacent connection terminals T3 in the first direction X (i.e., a length of an area between adjacent connection terminals T3 in the first direction X) is D3. A width of the connection terminal T4 in the first direction X is W4, and an interval between the adjacent connection terminals T4 in the first direction X (i.e., a length of an area between adjacent connection terminals T4 in the first direction X) is D4.

In the example illustrated, the interval D4 is equal to the interval D3 (D4=D3). In addition, the size of one connection terminal T3 corresponds to four connection terminals T4. At this time, a relationship in width between the connection terminals T3 and T4 can be expressed by the following equation.

W3=4×W4+3×D4

However, a relationship in size between the connection terminals T3 and T4 is not limited to this equation but can be generalized by the following equation. The number n is a positive integer.

W3=n×W4+(n−1)×D4

According to the present configuration example, the connectors corresponding to the connection terminals T3 to T5 can be disposed at regular pitches. Therefore, the wiring substrate SUBS can be easily formed and the manufacturing costs of the display device DSP can be suppressed.

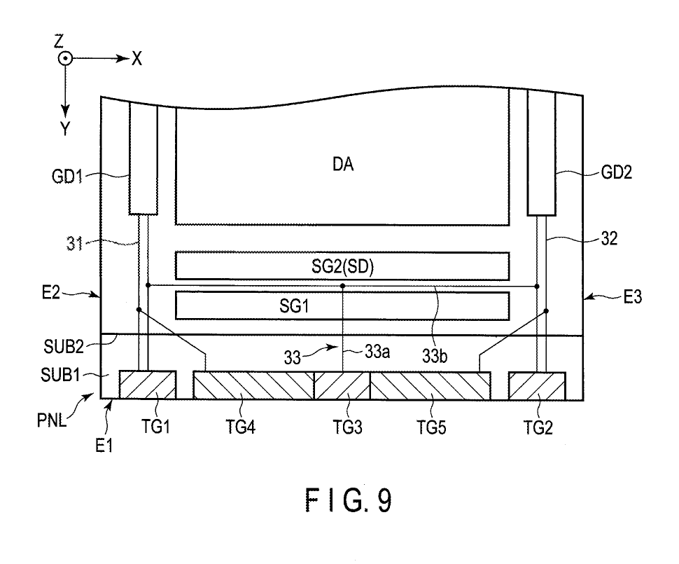

FIG. 9 is a plan view showing an arrangement example of supply lines 31, 32, and 33.

The supply lines 31 and 32 have been explained with reference to FIG. 2. The supply line 33 is a line for power supply formed on the first substrate SUB1 and composed of a plurality of lines to supply, for example, a plurality of constant voltages. In the example illustrated, the supply line 33 supplies power to the scanning line drive circuits GD1 and GD2. Alternatively, the supply line 33 may be electrically connected to the second switch group SG2 to supply power to a scanner SC which will be explained later. The supply line 33 includes a partial line 33a connecting the third connection terminal group TG3 with a node and a partial line 33b extending in a direction from the node of the partial line 33a to the positions of the sides E2 and E3. The partial line 33b is connected to the scanning line drive circuits GD1 and GD2 and is branched to be connected to the first connection terminal group TG1 and the second connection terminal group TG2, too. In other words, the supply line 33 is connected to the first to third connection terminal groups TG1 to TG3. The partial line 33b extends, for example, in the first direction X, between the first switch group SG1 and the second switch group SG2. The partial line 33b may penetrate the first switch group SG1 or the second switch group SG2 or may overlap the first switch group SG1 or the second switch group SG2 via an insulating film.

According to the configuration example, the scanning line drive circuits GD1 and GD2 obtain power from the same connection terminal. Furthermore, in the present configuration example, a length from the third connection terminal group TG3 to the supply line 33 is approximately equal to a length of the supply line 33 from the third connection terminal group TG3 to the scanning line drive circuit GD2. In other words, a power potential error and s power input timing error between the scanning line drive circuits GD1 and GD2 can be suppressed. In addition, the number of connection terminals used to supply power to the scanning line drive circuits GD1 and GD2 can be reduced.

FIG. 10 is a plan view showing an arrangement example of supply lines 41, 42, and 43.

The supply lines 41, 42, and 43 are formed on the first substrate SUB1. Video lines VL supply video signals from the fourth connection terminal group TG4 and the fifth connection terminal group TG5 to the second switch group SG2. In addition, the second switch group SG2 distributes the video signals to the signal lines S. The supply line 41 supplies a control signal for distribution of the video signals from the third connection terminal group TG3 to the second switch group SG2. The supply line 42 supplies a control signal for a test signal from the third connection terminal group TG3 to the second switch group SG2. The supply lines 43 supplies the test signal from the first connection terminal group TG1 to the second switch group SG2 or from the second connection terminal group TG2 to the second switch group SG2.

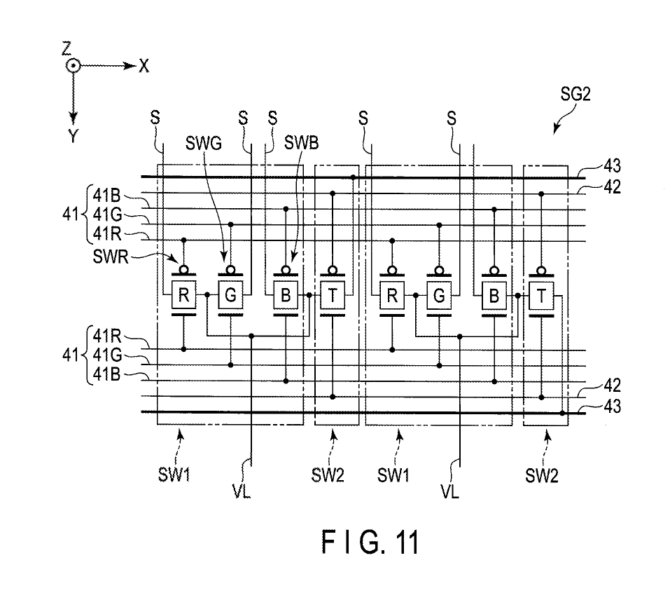

FIG. 11 is a diagram showing a configuration example of the second switch group SG2.

The second switch group SG2 comprises a plurality of switches SW1 and a plurality of switches SW2. In the example illustrated, the switches SW1 and SW2 are alternately disposed and arranged on the same straight line along the first direction X (side E1). The switch SW1 is an RGB switch which distributes the video signal supplied from one video line VL to a plurality of signal lines S. The switch SW2 is a test switch which controls supply of a test signal from the supply line 43 to the signal lines S.

The switch SW1 comprises an R switch SWR which supplies the video signal to a red sub-pixel SPXR, a G switch SWG which supplies the video signal to a green sub-pixel SPXG, and a B switch SWB which supplies the video signal to a blue sub-pixel SPXB. The R switch SWR, the G switch SWG, and the B switch SWB are, for example, arranged in the first direction X. Video lines VL are electrically connected to the R switch SWR, the G switch SWG, and the B switch SWB. In addition, supply lines 41R, 41G, and 41B of the supply lines 41 are electrically connected to the R switch SWR, the G switch SWG, and the B switch SWB, respectively. The supply lines 41R, 41G, and 41B supply control signals to control turning on/off the R switch SWR, the G switch SWG, and the B switch SWB, respectively. The switch SW2 is supplied with the test signal from the supply line 43 and is controlled to be turned on/off by the control signal supplied from the supply line 43.

In the example illustrated, the size of the switch SW1 in the second direction Y is approximately equal to the size of the switch SW2 in the second direction Y. In addition, the size of each of the R switch SWR, the G switch SWG, and the B switch SWB is approximately equal to the size of the switch SW2. For this reason, the switches SW1 and SW2 can be arranged in the first direction X without causing trouble in the arrangement of the supply lines 41, 42, and 43, in the second switch group SG2. In other words, the non-display area NDA on the side E1 can be narrowed in the display device DSP.

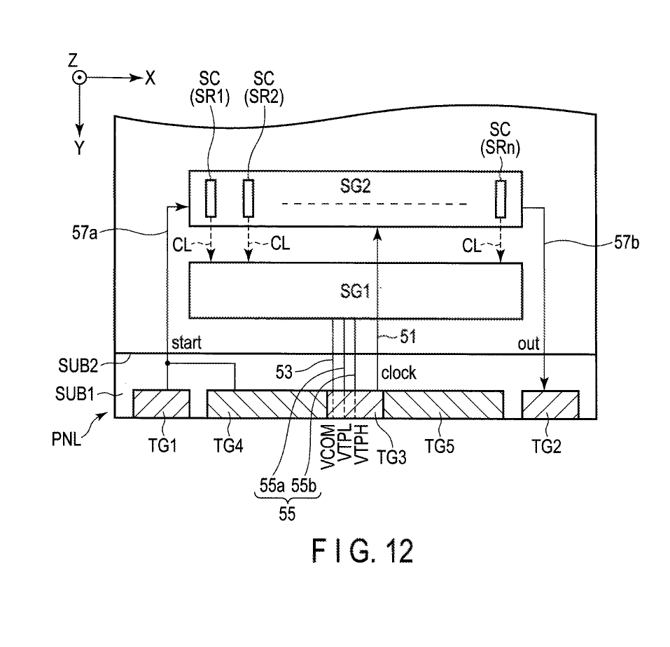

FIG. 12 is a plan view showing an arrangement example of supply lines 51, 53, 55, and 57, and a scanner SC.

The supply lines 51, 53, 55, and 57, and a scanner SC are disposed on the first substrate SUB1. The supply line 51 supplies a clock signal from the third connection terminal group TG3 to the scanner SC. The supply line 53 supplies a common voltage VCOM used for image display from the third connection terminal group TG3 to the first switch group SG1. The supply line 55 supplies a drive voltage used for detection of contact or approach of the object from the third connection terminal group TG3 to the first switch group SG1. The supply line 55 includes a low voltage line 55a for supplying a first drive voltage VTPL and a high voltage line 55b for supplying a second drive voltage VTPH higher than the first drive voltage VTPL. A supply line 57a supplies a start signal (start) from the fourth connection terminal group TG4 to the scanner SC. The supply line 57a is branched and is also connected to the first connection terminal group TG1. The start signal supplied from the supply line 57a is transferred to shift registers SR1 to SRn, sequentially, and output as an out signal (out) by a supply line 57b. The supply line 57b is branched and connected to the second connection terminal group TG2.

The scanner SC controls the first switch group SG1. The scanner SC and the first switch group SG1 are connected to each other by control lines CL. The scanner SC is composed a plurality of shift registers SR (SR1, SR2, . . . , SRn), and the shift registers SR are dispersed in the second switch group SG2. In other words, the switches SW1 and SW2 shown in FIG. 11 and the scanner SC are arranged along the first direction X (side E1). For this reason, the non-display area NDA on the side E1 can be narrowed as compared with the configuration example in which the switches SW1 and SW2 and the scanner SC are arranged in the second direction Y.

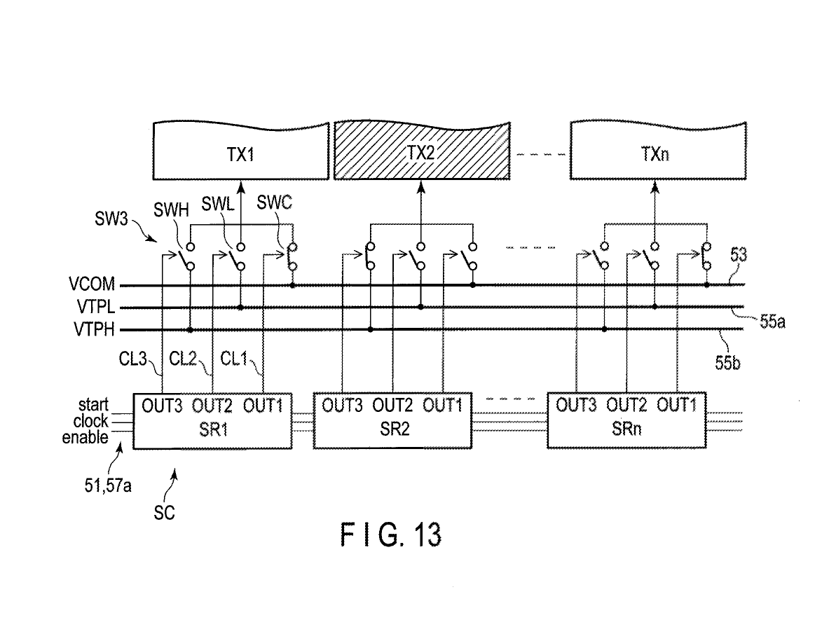

FIG. 13 is a diagram for explanation of operations of the scanner SC.

A configuration example in which the first drive voltage VTPL and the second drive voltage VTPH are supplied by different supply lines (the low voltage line 55a and the high voltage line 55b) is illustrated, but a configuration example in which the first drive voltage VTPL and the second drive voltage VTPH may be sequentially supplied to the scanner SC by one supply line for AC power may be employed.

The first switch group SG1 comprises a plurality of switches SW3. The switches SW3 change the destination of connection of the drive electrodes TX (common electrodes CE). Each switch SW3 comprises a common voltage switch SWC which makes connection or disconnection (turning on and off) between the drive electrode TX and the supply line 53, a low voltage switch SWL which turns on and off the drive electrode TX and the low voltage line 55a, and the high voltage switch SWH which turns on and off the drive electrode TX and the high voltage line 55b. The common voltage switch SWC, the low voltage switch SWL, and the high voltage switch SWH are turned on and off by the signals from the scanner SC.

In the display period, the common voltage switch SWC of each switch SW3 is turned on, and the low voltage switch SWL and the high voltage switch SWH of each switch SW3 are turned off. The common voltage VCOM is supplied to the drive electrodes TX1 to TXn by turning on each common voltage switch SWC. In the touch detection period, for example, the drive signals are sequentially supplied to the drive electrodes TX1 to TXn. The drive electrode TX which is a target of supply of the drive signal (hereinafter called a target of drive) is different from the remaining drive electrodes TX with respect to the manner of connecting the switch SW3. The drive electrode TX2 is assumed to be driven in the touch detection period.

The scanner SC comprises the shift registers SR (SR1 to SRn) provided for the respective drive electrodes TX1 to TXn. Each shift register SR operates based on a start signal (start), a clock signal (clock), and an enable signal (enable) supplied from the IC chip I2 (detection circuit RC).

The shift register SR is connected to the common voltage switch SWC via the first control line CL1, connected to the low voltage switch SWL via the second control line CL2, and connected to the high voltage switch SWH via the third control line CL3.

The shift register SR outputs a control signal OUT1 to turn on/off the common voltage switch SWC to the first control line CL1, a control signal OUT2 to turn on/off the low voltage switch SWL to the second control line CL2, and a control signal OUT3 to turn on/off the high voltage switch SWH to the third control line CL3.

The common voltage switch SWC of the drive electrode TX2 which is the drive target is turned off, and the common voltage switches SWC of the remaining drive electrodes TX are turned on. The connection destination of the drive electrode TX2 which is the drive target is swung by the low voltage line 55a and the high voltage line 55b. The low voltage switch SWL and the high voltage switch SWH of the drive electrode TX2 are alternately turned on/off, a sensor drive signal Stx which toggles between the first drive voltage VTPL and the second drive voltage VTPH is thereby generated, and the sensor drive signal Stx is supplied to the drive electrode TX2. The detection circuit RC detects the object which contacts or approaches the display area DA, based on the detection signals (above-explained sensor detection signals Srx) obtained from the detection electrodes RX1 to RXm with respect to the sensor drive signal Stx. To alternately turned on/off the low voltage switch SWL and the high voltage switch SWH corresponding to the drive electrode TX which is the target of drive, control signals OUT2 and OUT3 of the shift register SR corresponding to the drive electrode TX have mutually opposite phases.

The drive electrodes TX of drive targets may be selected sequentially from the drive electrode TX1 to the drive electrode TXn or may be selected in the other orders. In addition, a plurality of drive electrodes TX may be selected as drive targets at the same time. Furthermore, the drive electrodes TX1 to TXn may be selected as the target of drive at one time during one touch detection period or the drive electrodes TX1 to TXn may be selected as the targets of drive at a plurality of times during two or more touch detection periods.

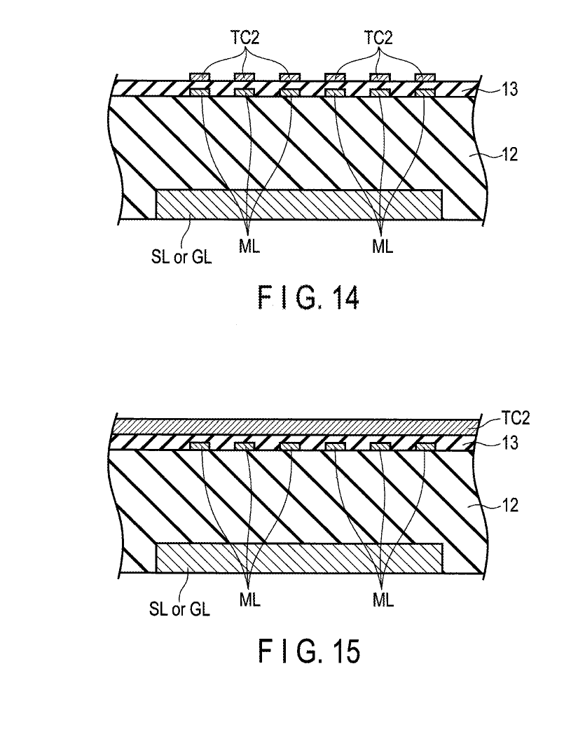

FIG. 14 is a cross-sectional view showing a configuration example of lines drawn from first to fifth connection terminal groups.

The lines drawn from the first to fifth connection terminal groups TG1 to TG5 are multilayer wiring lines formed of any one of the signal line layer SL, the scanning line layer GL, and the metal layer ML. The signal line layer SL is disposed in the same layer as the above-explained signal lines S and entirely formed in the same process as the signal lines S. The scanning line layer GL is disposed in the same layer as the above-explained scanning lines G and entirely formed in the same process as the scanning lines G. The metal layer ML is disposed in the same layer as the above-explained metal layer M and entirely formed in the same process as the metal layer M. The present configuration example may employ three-layer wiring using all the signal line layer SL, the scanning line layer GL, and the metal layer ML or may employ two-layer wiring using two of the signal line layer SL, the scanning line layer GL, and the metal layer ML. For example, the signal line layer SL corresponds to the first wiring layer, and the metal layer ML corresponds to the second wiring layer.

The signal line layer SL, the scanning line layer GL, and the metal layer ML are insulated fro each other by an interlayer insulating film such as the insulating film 12 which covers the signal line layer SL. The first wiring layer and the second wiring layer are opposed via the interlayer insulating film when intersecting each other. For this reason, according to the present configuration example, the lines drawn from the first to fifth connection terminal groups TG1 to TG5 can be made to intersect without short-circuited.

The metal layer ML is opposed to the transparent conductive layer TC2 via the insulating film 13. The transparent conductive layer TC2 is disposed in the same layer as the above-explained pixel electrodes PE and entirely formed in the same process as the pixel electrodes PE. In the example illustrated, the transparent conductive layer TC2 includes a plurality of wires disposed along the metal layer ML. The wires are spaced apart from each other at positions opposed to gaps between the wires of the metal layer ML.

According to the present configuration example, the transparent conductive layer TC2 can prevent entry of moisture into the metal layer ML. For this reason, according to the present configuration example, corrosion of the metal layer ML can be suppressed even if the metal layer ML is formed of a material weak in moisture. In addition, since the transparent conductive layer TC2 is composed of wires, undesired formation of the capacitance between the transparent conductive layer TC2 and the signal line layer SL, the scanning line layer GL and the like can be suppressed according to the present configuration example. FIG. 15 is a cross-sectional view showing another configuration example of lines drawn from the first to fifth connection terminal groups.

In the example illustrated, the transparent conductive layer TC2 is formed in a flat plate opposed to the metal layer ML. According to the present configuration example, entry of moisture into the metal layer ML can be prevented more effectively than the configuration example shown in FIG. 14.

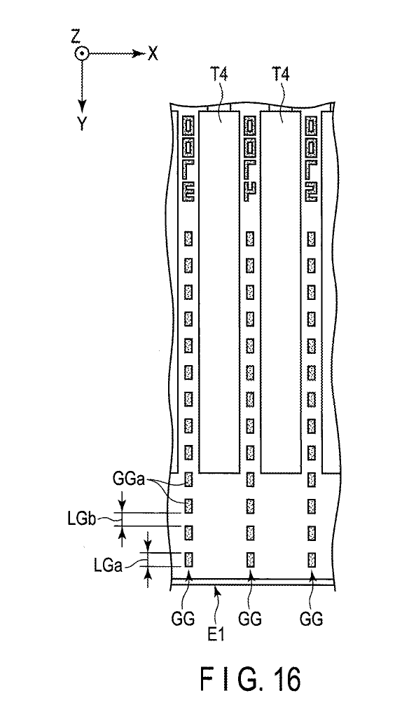

FIG. 16 is a plan view showing an arrangement example of connection terminals 4 and gauges GG.

The gauges GG are disposed between adjacent connection terminals T4. The gauge GG is composed of a plurality of segments GGa arranged in the second direction Y and spaced apart from each other, and extends to the side E1. The length of each segment GGa in the second direction Y is LGa, and a length between the segments GGa is LGb. The length LGa is, for example, equal to the length LGb. The gauges GG are formed between, for example, all the connection terminals T1 to T5 but are not limited to this example and the connection terminals adjacent without interposition of the gauges GG may be disposed between the gauges GG. According to the present configuration example, damage condition of the side E1 can be diagnosed by measuring the number of segments GGa in each gauge GG. Therefore, the lengths LGa and LGb are not limited if helpful to diagnosis of the damage condition and, for example, each of the lengths is 10 μm.

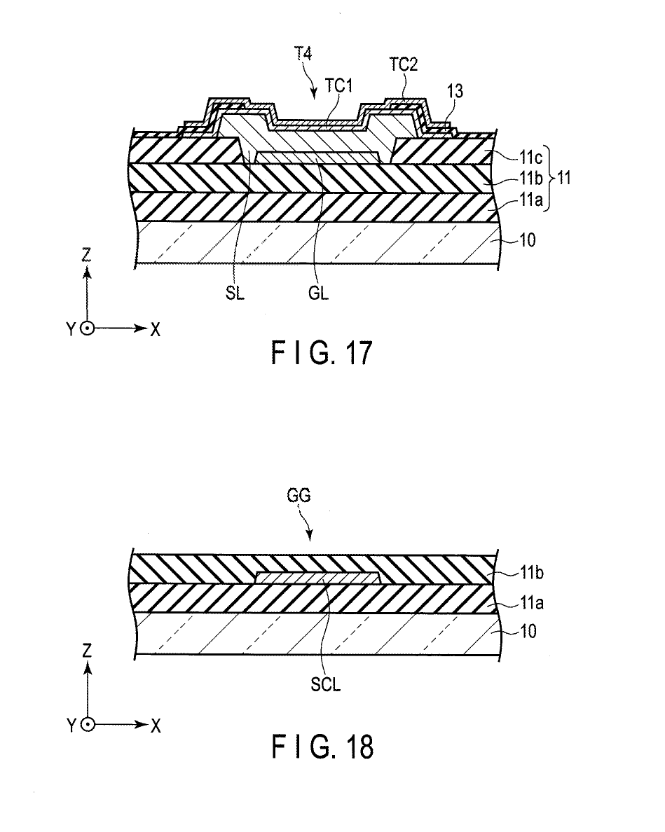

Next, the cross-sectional structure of the connection terminal T4 and the gauge GG shown in FIG. 16 will be explained with reference to FIG. 17 and FIG. 18. The cross-sections shown in FIG. 17 and FIG. 18 are cross-sections seen along the first direction X. The connection terminals T1 to T3 and T5 have the same cross-sectional structure as that of the connection terminal T4, and their explanations are omitted.

FIG. 17 is a cross-sectional view showing a configuration example of the connection terminal T4.

In the connection terminal T4, the scanning line layer GL, the signal line layer SL, the transparent conductive layer TC1, and the transparent conductive layer TC2 are stacked in this order. The transparent conductive layer TC1 is formed in the same layer as the above-explained drive electrodes TX (common electrodes CE) and entirely formed in the same process as the drive electrodes TX.

The scanning line layer GL is out of contact with the insulating film 11c. The signal line layer SL covers the scanning line layer GL, contacts the insulating film 11b, and covers the edge portion of the insulating film 11c which is opposed to the scanning line layer GL. The transparent conductive layer TC1 covers the signal line layer SL and is disposed on the insulating film 11c on both end sides of the signal line layer SL. The insulating film 13 is disposed on the transparent conductive layer TC1 except an area opposed to the scanning line layer GL in the third direction Z. The transparent conductive layer TC2 is formed between the transparent conductive layer TC1 and the insulating film 13 and is in contact with the transparent conductive layer TC1 in the area opposed to the scanning line layer GL in the third direction Z. Edge portions of the transparent conductive layers TC1 and TC2 spaced apart from the signal line layer SL in the first direction X are opposed in the third direction Z.

FIG. 18 is a cross-sectional view showing a configuration example of the gauge GG.

The gauge GG is formed by the semiconductor layer SCL. The semiconductor layer SCL is formed in the same layer as the semiconductor layer SCL of the pixel switch PSW and entirely formed in the same process. In other words, the semiconductor layer SCL of the gauge GG is disposed on the insulating film 11a and covered with the insulating film 11b.

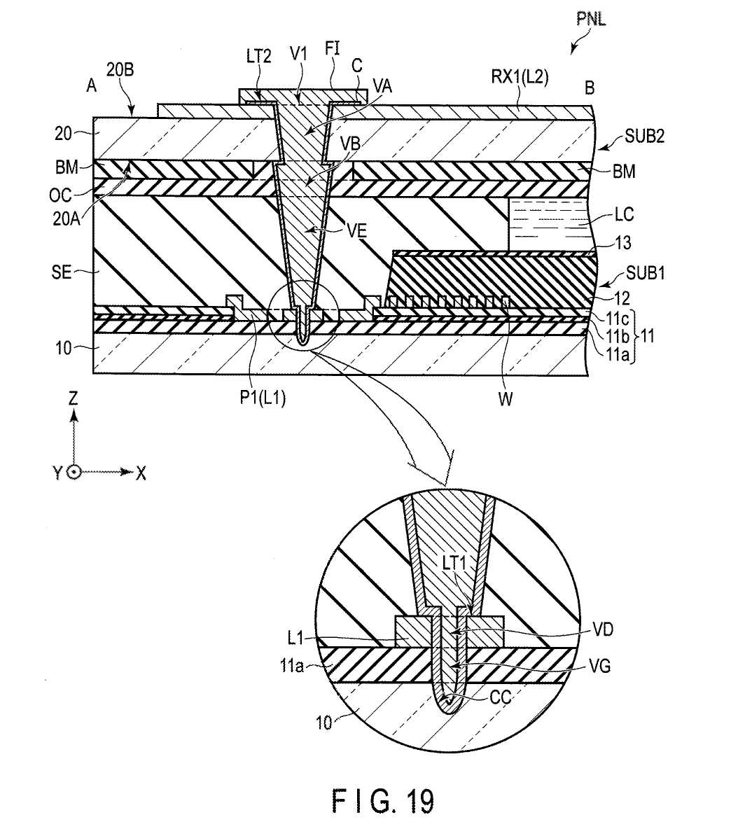

Next, a configuration example of the contact hole V will be explained with reference to FIG. 19 which is an enlarged cross-sectional view of an area including the contact hole V1.

FIG. 19 is a cross-sectional view showing the display panel PNL cut along line A-B in FIG. 1.

The first substrate SUB1 comprises a first insulating substrate 10, a first conductive layer L1 (pad P1) located on a side of the first insulating substrate 10 which is opposed to the second substrate SUB2, and a detection line W located in the same layer as the first conductive layer L1 and formed of the same material as the first conductive layer L1. The second substrate SUB2 comprises a second conductive layer L2 on a surface 20B on a side opposite to the surface 20A on the side of the second insulating substrate 20 which is opposed to the first substrate SUB1. The sealing material SE is disposed between the first substrate SUB1 and the second substrate SUB2, in the area where the contact hole V1 is formed. The light-shielding layer BM is out of contact with the contact hole V1, and the overcoat layer OC is disposed between the contact hole V1 and the light-shielding layer BM.

The contact hole V1 is composed of through holes VA, VB, VE, VD, and VG, and a concavity CC. A diameter of each of the through holes VA, VB, VE, VD, and VG on the side on which an arrow of the third direction Z is located is larger and a diameter on the opposite side in the third direction Z is smaller. The through hole (first through hole) VA penetrates the first conductive layer L1 and the second insulating substrate 20 in the third direction Z. The through holes VB and VE (third through holes) are formed in an organic insulating film located between the first conductive layer L1 and the second insulating substrate 20 and penetrate the overcoat layer OC and the sealing material TG, respectively, in the third direction Z. The through hole VB connects with the through hole VA, and the through hole VE connects with the through hole VD. The through hole VD (second through hole) is formed at a position opposed to the through hole VA of the first conductive layer L1 to penetrate the first conductive layer L1. The through hole VG connects with the through hole VD and penetrates the insulating film 11a. The concavity CC connects with the through hole VGB to be opposed to the through hole VD in the third direction Z, and is formed on the first insulating substrate 10.

The connecting material C which electrically connects the first conductive layer L1 with the second conductive layer L2 is in contact with inner surfaces of the second conductive layer L2, the second insulating substrate 20, the overcoat layer OC, the sealing material SE, the first conductive layer L1, the insulating film 11a and the first insulating substrate 10, which are formed by the contact hole V1. The connecting material C is also in contact with an upper surface LT2 on a side opposite to the side of the first conductive layer L1 which is opposed to the surface 20B. In addition, the connecting material C is also in contact with an upper surface LT1 on the side of the first conductive layer L1 exposed through the through hole VE, which is opposed to the second substrate SUB2.

In addition, the contact hole V1 surrounded by the connecting material C is filled with the filling material F1. The filling material FI is also disposed on the second conductive layer L2. The filling material FI is not particularly limited if it can protect the connecting material C, and may be formed of an organic insulating material or a conductive material such as a resin material containing conductive particles.

As explained above, according to the embodiments, a display device in which the frame can be narrowed can be provided. The summary of the structure of the display panel PNL which can be narrowed according to the embodiments will be further explained below. In the present configuration example, the terminal area NA can be particularly narrowed.

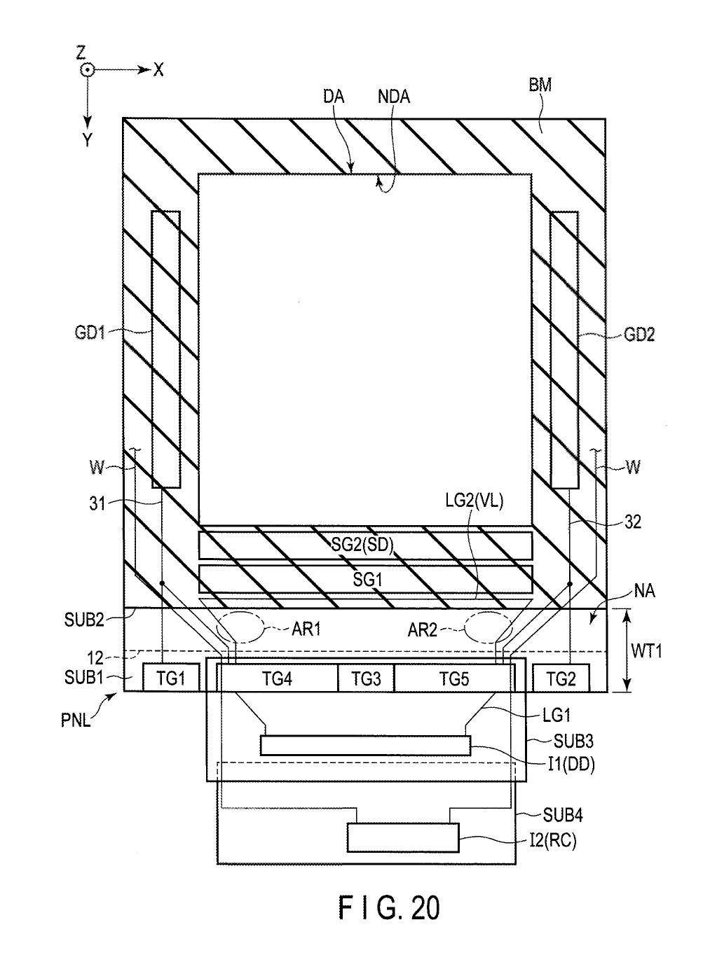

FIG. 20 is a plan view showing a configuration example of a non-display area NDA and a terminal area NA.

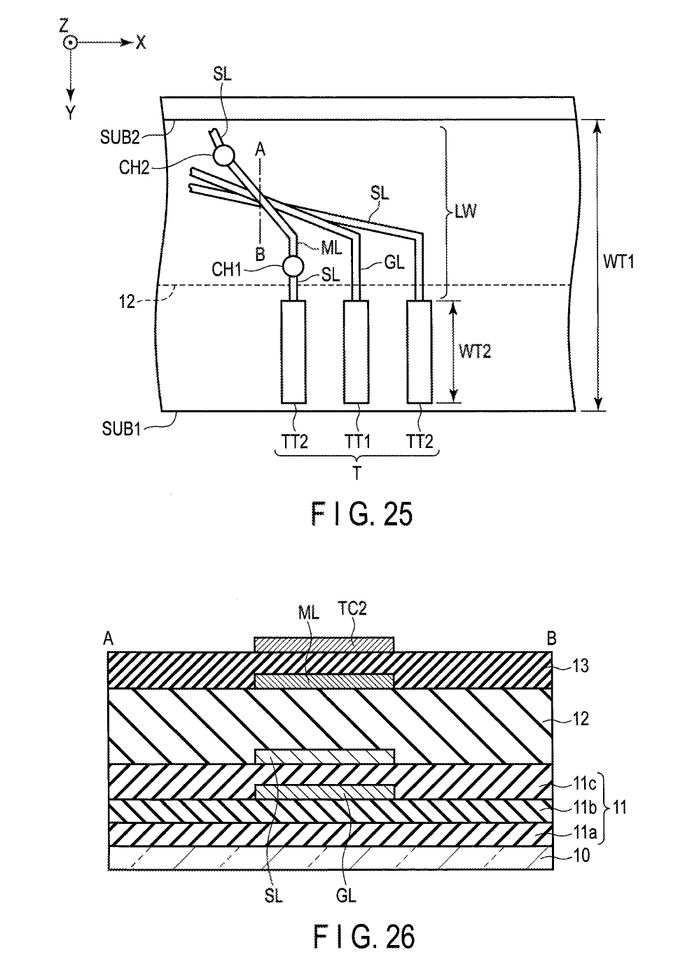

The display panel PNL is formed by bonding the first substrate SUB1 to the second substrate SUB2, and the first substrate SUB1 comprises the scanning line drive circuits GD1 and GD2 on the right and left sides of the frame-shaped peripheral area (non-display area NDA) and the signal line drive circuit SD on the lower side. In addition, the first substrate SUB1 includes an elongated portion (terminal area NA) extending to be exposed from the lower edge portion of the second substrate SUB2, and the elongated portion includes a plurality of connection terminals T connected to the wiring substrate SUBS and the connection lines connected from the connection terminals T to the circuits and other lines. The terminal area NA corresponds to an area between a lower edge of the second substrate SUB2 and a lower edge of the first substrate SUB1. The second substrate SUB2 comprises the light-shielding layer BM in the peripheral area, the light-shielding layer BM on the lower side of the second substrate SUB2 overlaps the signal line drive circuit SD but does not overlap the connection terminals T (first to fifth connection terminal groups TG1 to TG5) in the terminal area NA of the first substrate SUB1 extending from second substrate SUB2. In addition, right and left sides of the light-shielding layer BM of the second substrate SUB2 overlap the scanning line drive circuits GD1 and GD2, respectively. In the present structure, the light-shielding layer BM formed in a peripheral area of the second substrate SUB2 has a common width on upper, lower, right and left sides and, for example, the width is in a range from 500 μm to 1000 μm. However, if the width is in a range from 500 μm to 1000 μm, the widths on the upper, lower, right and left sides of the light-shielding layer BM formed in the peripheral area of the second substrate SUB2 may be different from each other or the width of at least one of the sides may be different from the widths of the other sides. The terminal area NA does not overlap the light-shielding layer BM of the counter-substrate. A width WT1 of the terminal area NA can be reduced by the effects of the present embodiments and, the width is 600 μm in the present structure and is, for example, a length in a range from 200 μm to 2000 μm. In addition, the connection terminal T is formed in a rectangular shape having a longer axis in the second direction Y and a shorter axis in the first direction X as explained with reference to, for example, FIG. 25, and features that a length of the connection terminal T in the longer axis direction (longer axis width WT2) is, for example, in a range from 200 μm to 300 μm, and that the width WT1 of the terminal area NA in the second direction Y is approximately one to three times as great as the longer axis width WT2 of the connection terminal T are desirable for narrower frame (WT2<WT1≦3×WT2).

Next, a configuration example of the lead-out line LW drawn from the connection terminal T will be explained.

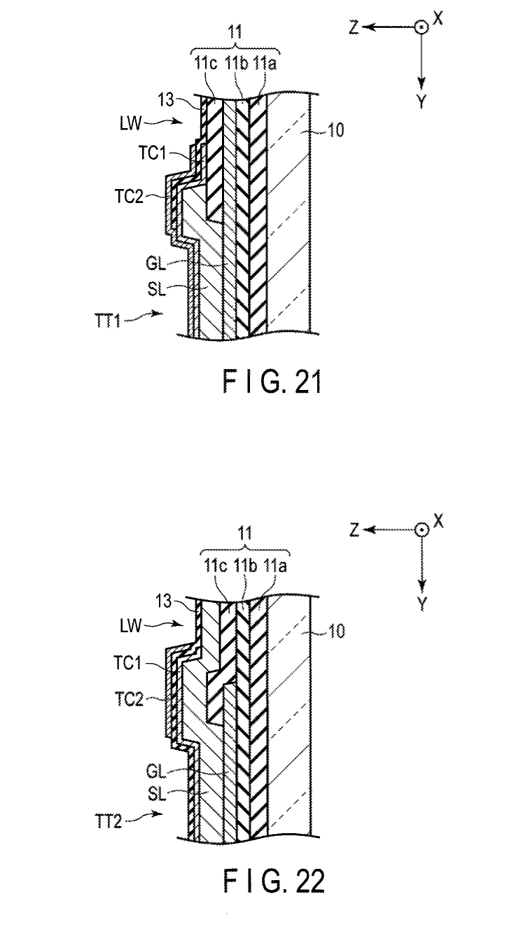

FIG. 21 is a cross-sectional view showing a configuration example of a lead-out line LW. FIG. 22 is a cross-sectional view showing another configuration example of the lead-out line LW.

As shown in FIG. 21 and FIG. 22, the connection terminals T include two types of connection terminals, i.e., a first connection terminal TT1 and a second connection terminal TT2. The first connection terminal TT1 is configured by stacking a first wiring layer (scanning line layer GL) formed of the same material as the scanning lines G, a second wiring layer (signal line layer SL) formed of the same material as the signal lines S, and at least one transparent electrode (transparent conductive layers TC1 and TC2), as shown in FIG. 21, in the present structure, and the first wiring layer is drawn to the display area DA side as the lead-out line LW. The second connection terminal TT2 is configured by stacking a first wiring layer (scanning line layer GL) formed of the same material as the scanning lines G, a second wiring layer (signal line layer SL) formed of the same material as the signal lines S, and at least one transparent electrode (transparent conductive layers TC1 and TC2), as shown in FIG. 22, in the present structure, and the second wiring layer is drawn to the display area DA side as the lead-out line LW. The drawings disclose the feature that at least one transparent electrode formed in each of the first connection terminal TT1 and the second connection terminal TT2 is composed of two layers, the first layer, i.e., the transparent conductive layer TC1 is formed of the same material as, for example, the common electrodes CE in the display area DA, and the second layer, i.e., the transparent conductive layer TC2 is formed of the same material as, for example, the pixel electrodes PE in the display area DA.

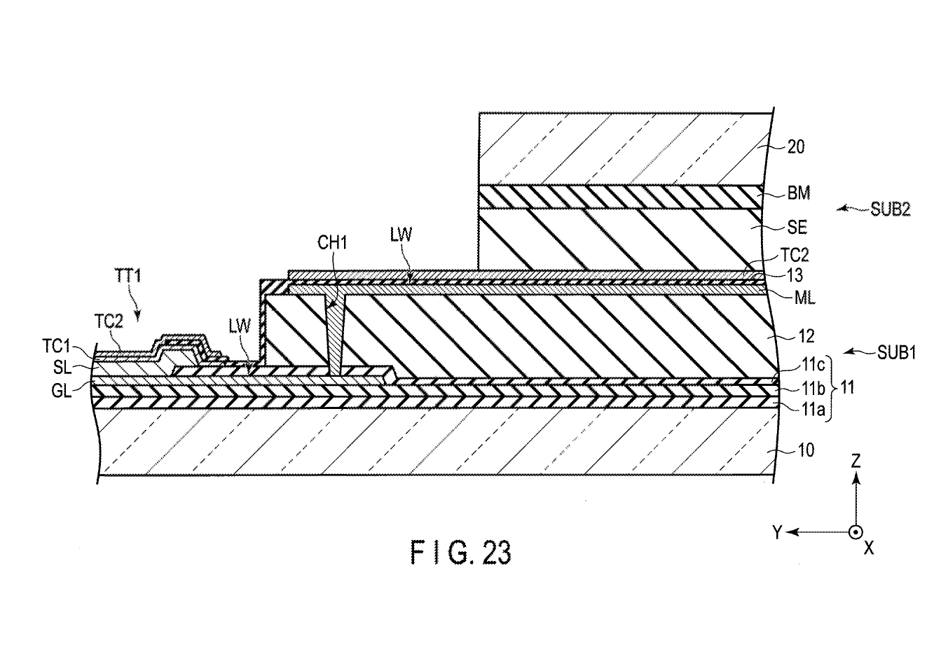

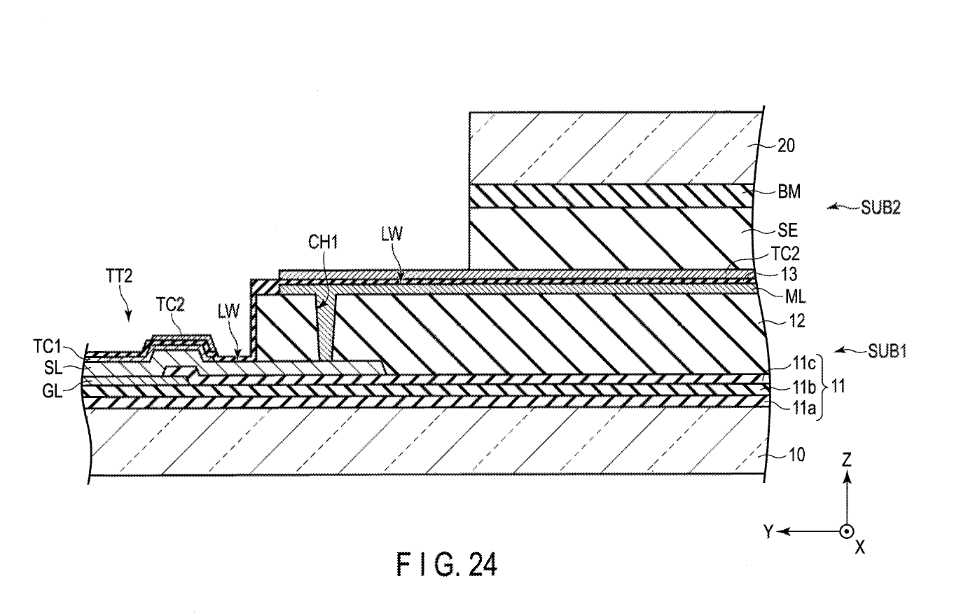

Next, a relay structure of the lead-out lines LW drawn from the first connection terminal TT1 and the second connection terminal TT2 will be explained with reference to FIG. 23 and FIG. 24.

FIG. 23 is a cross-sectional view showing an example of connection of the lead-out line LW shown in FIG. 21. FIG. 24 is a cross-sectional view showing an example of connection of the lead-out line LW shown in FIG. 22.

As shown in FIG. 23 and FIG. 24, the insulating film 12 (organic insulating film) is formed to extend near the connection terminal T in the terminal area NA, similarly to the side of the display area DA, and a third line is formed on the insulating film 12 by the metal layer ML which is used as the connection line relaying the lead-out line LW. The third line is considered to employ either or both of the structure of being connected to the first wiring layer (scanning line layer GL) through the contact hole CH1 formed in the insulating films 12 and 11c near the first connection terminal TT1 as shown in FIG. 23, and the structure of being connected to the second wiring layer (signal line layer SL) through the contact hole CH1 formed in the insulating film 12 near the second connection terminal TT2 as shown in FIG. 24. As a width (frame width) of the terminal area NA in the second direction is shorter, a number of lines can hardly be formed of the first lines (scanning line layer GL) or the second lines (signal line layer SL) alone due to restriction to the line forming area. The display device DSP can use the third line as the relay line of the lead-out line LW by using the third line (metal layer ML) and the organic insulating film (insulating film 12) and can avoid the restriction to the line forming area by three lines.

Next, a structure at an intersection of the first to third lines will be explained with reference to FIG. 25 and FIG. 26.

FIG. 25 is a plan view showing intersecting lead-out lines LW. FIG. 26 is a cross-sectional view seen along line A-B in FIG. 25.

The display device DSP includes at least one portion at which at least two of three lines overlap as shown in FIG. 25, in the terminal area NA. To connect the third line (metal layer ML) to the connection terminal T (first connection terminal TT1 or second connection terminal TT2), the terminal area NA includes at least one of the contact holes CH1 and CH2 formed of the insulating film 12 or 11c. The contact holes CH1 and CH2 may be formed at the portion at which the first line (scanning line layer GL) and the third line (metal layer ML) are to be connected to each other or the portion at which the second line (signal line layer SL) and the third line (metal layer ML) are to be connected to each other, and the position for formation is not particularly limited.

In the present configuration example, three lead-out lines LW are illustrated. One lead-out line is composed of the first line (scanning line layer GL) drawn from the first connection terminal TT1. Another lead-out line is composed of the second line (signal line layer SL) drawn from the second connection terminal TT2. The other lead-out line is composed of the second line (signal line layer SL) drawn from the second connection terminal TT2, the third line (metal layer ML) connected to the second line (signal line layer SL) through the contact hole CH1 near the second connection terminal TT2, and the second line (signal line layer SL) connected to the third line (metal layer ML) through the contact hole CH2 on the edge portion side of the second substrate SUB2. The third line (metal layer ML) may be thus connected to each drive circuit but may be used to bridge the first line (scanning line layer GL) and the second line (signal line layer SL).

For example, portions at which the lines are easily concentrated and a bridge structure using the third line (metal layer ML) is concentrated are illustrated as areas AR1 and AR2 in FIG. 20. The areas AR1 and AR2 are located near right and left edges of the second line group LG2.

The portions at which the bridge structure using the third line (metal layer ML) is concentrated are not limited to the areas AR1 and AR2. Particularly, a narrow frame structure of the display pane PNL can be obtained by the three-layer wiring structure in the terminal area NA. FIG. 26 is a cross-sectional view seen along line A-B in FIG. 25, and a transparent electrode (transparent conductive layer TC2) which overlaps the third line (metal layer ML) is provided (as a measure to prevent moisture) as also shown in FIG. 14. The transparent electrode (transparent conductive layer TC2) is formed on the insulating film 13 which covers the third line (metal layer ML), formed in the same shape as the third line (metal layer ML), and is electrically floating. The transparent conductive layer TC2 is, for example, the pixel electrode PE formed in the display area DA, and may be or may not be covered with the alignment film.

The third line (metal layer ML) and the second line (signal line layer SL) are formed of a metal material containing aluminum, and the first line (scanning line layer GL) is formed of a metal material containing molybdenum and tungsten. For this reason, the third line and the second line have lower resistance than the first line and, desirably, the first line is used as the line such as the power supply line, which can be sufficiently formed of, for example, a material other than a low resistance material, and the second line and the third line are primarily used as the lines in which the resistance value is considered important.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a first substrate including a first area in which an image is displayed and a second area located around the first area; and
a wiring substrate overlapping a first side and the second area of the first substrate,
the first substrate comprising:
a third connection terminal group;
a fourth connection terminal group located on one of sides of the third connection terminal group and composed of a connection terminal smaller than a connection terminal of the third connection terminal group; and
a fifth connection terminal group located on the other side of the third connection terminal group and composed of a connection terminal smaller than a connection terminal of the third connection terminal group.

2. The display device of claim 1, further comprising:
a first connection terminal group disposed near one of edges of the first side in the second area; and
a second connection terminal group disposed near the other edge of the first side in the second area,
wherein
the third connection terminal group is disposed between the first connection terminal group and the second connection terminal group,
the fourth connection terminal group is disposed between the first connection terminal group and the third connection terminal group, and
the wiring substrate is located between the first connection terminal group and the second connection terminal group and electrically connected to the third, fourth, and fifth connection terminal groups.

3. The display device of claim 2, wherein
the first to fifth connection terminal groups are arranged in a first direction, and satisfies a relational equation
W3=n×W4+(n−1)×D4
where a width of the connection terminal of the third connection terminal group in the first direction is W3, a width of the connection terminal of the fourth connection terminal group in the first direction is W4, an interval between adjacent connection terminals of the fourth connection terminal group in the first direction is D4, and n is an arbitrary positive integer.

4. The display device of claim 2, wherein
a size and a pitch of the connection terminals of the third connection terminal group are equal to a size and a pitch of the connection terminals of the first connection terminal group and equal to a size and a pitch of the connection terminals of the second connection terminal group.

5. The display device of claim 2, wherein
the first substrate further comprises:
a second side extending from one of edges of the first side in a direction intersecting the first side;
a third side extending from the other edge of the first side and opposed to the second side;
a first scanning line drive circuit disposed along the second side in the second area to control supply of a scan signal to the first area;
a second scanning line drive circuit disposed along the third side in the second area to control supply of a scan signal to the first area; and
a first supply line supplying power to the first and second first scanning line drive circuits, and
the first supply line is connected to the first, second, and third connection terminal groups.

6. The display device of claim 2, wherein
the first substrate further comprises:
a plurality of pixel electrodes formed in the first area;
a plurality of signal lines supplying video signals to the plurality of pixel electrodes;
a plurality of first switches formed in the second area to distribute the video signals to the plurality of signal lines; and
a second supply line supplying control signals from the third connection terminal group to the plurality of first switches.

7. The display device of claim 6, wherein
the first substrate further comprises a plurality of second switches controlling supply of test signals to the plurality of signal lines, and
the plurality of first switches and the plurality of second switches are arranged along the first side.

8. The display device of claim 7, wherein
a size of each of the first switches in a direction orthogonal to a direction of arrangement of the first and second switches is equal to a size of each of the second switches in a direction orthogonal to a direction of arrangement of the first and second switches.

9. The display device of claim 2, wherein
the first substrate further comprises:
a plurality of pixel electrodes disposed in the first area;
a plurality of common electrodes opposed to the plurality of pixel electrodes and extending in a direction intersecting the first side;
a plurality of third switches disposed along the first side to change destinations of connection of the plurality of common electrodes;
a third supply line supplying a common voltage used for image display from the third connection terminal group to the plurality of third switches; and
a fourth supply line supplying a drive voltage used to detect contact or approach of an object from the third connection terminal group to the plurality of third switches.

10. The display device of claim 9, wherein
the first substrate further comprises a scanner controlling the plurality of third switches, and
the scanner and the plurality of first switches are arranged along the first side.

11. The display device of claim 10, wherein
the first substrate further comprises:
a fifth supply line supplying a clock signal from the third connection terminal group to the scanner; and
a sixth supply line supplying a start signal from the fourth connection terminal group to the scanner, and
the sixth supply line is branched and also connected to the first connection terminal group.

12. The display device of claim 2, wherein
the first substrate further comprises:
a first wiring layer drawn from one of the first to fifth connection terminal groups;
a first insulating film covering the first wiring layer;
a second wiring layer drawn from one of the first to fifth connection terminal groups and opposed to the first wiring layer via the first insulating film;
a second insulating film covering the second wiring layer; and
a transparent conductive layer opposed to the second wiring layer via the second insulating film.

13. The display device of claim 12, wherein
the transparent conductive layer includes a plurality of wires disposed along a plurality of lines of the second wiring layer, and
the plurality of wires are spaced apart from each other at positions opposed to gaps between the plurality of lines of the second wiring layer.

14. A display device, comprising:
a first substrate including a first area in which an image is displayed and a second area located around the first area;
a second substrate opposed to the first substrate; and
a wiring substrate overlapping a first side of the first substrate and the second area,
wherein
the first substrate comprises a connection terminals disposed near an edge of the first side in the second area,
the second area of the first substrate includes a first portion overlapping the second substrate and a second portion extending from an edge portion of the second substrate,
the plurality of connection terminals are formed at the second portion,
the second portion includes a first line, a first insulating film covering the first line, a second line on the first insulating film, a second insulating film covering the second line, and a third line on the second insulating film, and
the third line is connected to at least one of the plurality of connection terminals through a contact hole formed in the second insulating film.

15. The display device of claim 14, wherein
the second portion further includes the first line formed of a first wiring layer connected to the plurality of connection terminals and the second line formed of a second wiring layer.

16. The display device of claim 15, wherein
the second portion includes at least one area in which the third line, the second line and the first line overlap.

17. The display device of claim 16, wherein
the plurality of connection terminals include a first connection terminal and a second connection terminal,
the first wiring layer and the second wiring layer are stacked in the first contact terminal, and the first wiring layer is drawn to a display area side as a first line, and
the first wiring layer and the second wiring layer are stacked in the second contact terminal, and the second wiring layer is drawn to a display area side as a second line.

18. The display device of claim 14, wherein
each of the plurality of connection terminals has a longer axis and a shorter axis, and a distance of elongation of the second portion from the edge portion of the second substrate is one to three times as long as a longer axis width of the connection terminal.

19. The display device of claim 18, wherein
the second substrate comprises a light-shielding layer in the peripheral area, and a width of the light-shielding layer is constant in a peripheral area.
